(19) United States
(12) Patent Application Publication
(10) Pub. No.: US 2013/0106199 A1
(43) Pub. Date: May 2, 2013

(54) MASTER SLAVE RADIO CONTROL SYSTEM

(71) Applicant: Earl David Forrest, Asheboro, NC (US)

(72) Inventor: Earl David Forrest, Asheboro, NC (US)

(21) Appl. No.: 13/287,397

(22) Filed: Nov. 2, 2011

(51) Int. Cl. H01H 47/00

(52) U.S. Cl. 307/113

(57) ABSTRACT

A system for controlling distribution of power includes a line-powered electrical device that has a radio, a plurality of electrical components disposed electrically downstream from the line-powered electrical device and receiving power from the line-powered electrical device, and a first controller wirelessly receiving or sending signals to and/or from the radio included with the line-powered electrical device.

### BACKGROUND

Line-powered devices that contain radios for the purposes of communicating with other devices are known. Typical radio-enabled battery-powered occupancy sensors are used to communicate with line-powered devices to turn electrical loads on and off, as an example, and thus save energy if a given space is unoccupied. Also known are energy harvesting switches that also contain a radio to communicate with line-powered devices to turn off power remotely without the need of wires between the switch and the line-powered device controlling the load.

### SUMMARY

In an embodiment shown herein, a system for controlling distribution of power includes a line-powered electrical device that has a radio, a plurality of electrical components disposed electrically downstream from the line-powered electrical device and receiving power from the line-powered electrical device, and a first controller wirelessly receiving or sending signals to and/or from the radio included with the line-powered electrical device.

In accordance with a further embodiment disclosed herein, a method for controlling distribution of power includes providing a electrical device including a radio, providing line power to the electrical device including a radio, disposing a plurality of electrical components electrically downstream from the line-powered electrical device, providing power to the electrical components via the electrical device, and receiving and/or sending signals via the radio to a remotely placed first controller.

These and other features of the present invention can be best understood from the following specification and drawings, the following of which is a brief description.

### BRIEF DESCRIPTION OF THE DRAWINGS

FIG. 1 shows a block diagram of a radio receiving signal from slave switches.

FIG. 2 shows details of a slave switch as shown in FIG. 1.

FIG. 3 shows a perspective view of line-powered device having inputs.

FIG. 3A is a plan drawing of the back of the line-powered device having inputs as shown in FIG. 3.

FIGS. 4A-4E show several embodiments of a line-powered device with a radio transmitter and contact switches.

FIGS. 5A-C show a further embodiment of the invention wherein the line-powered device controls several devices downstream of that line-powered device.

### DETAILED DESCRIPTION

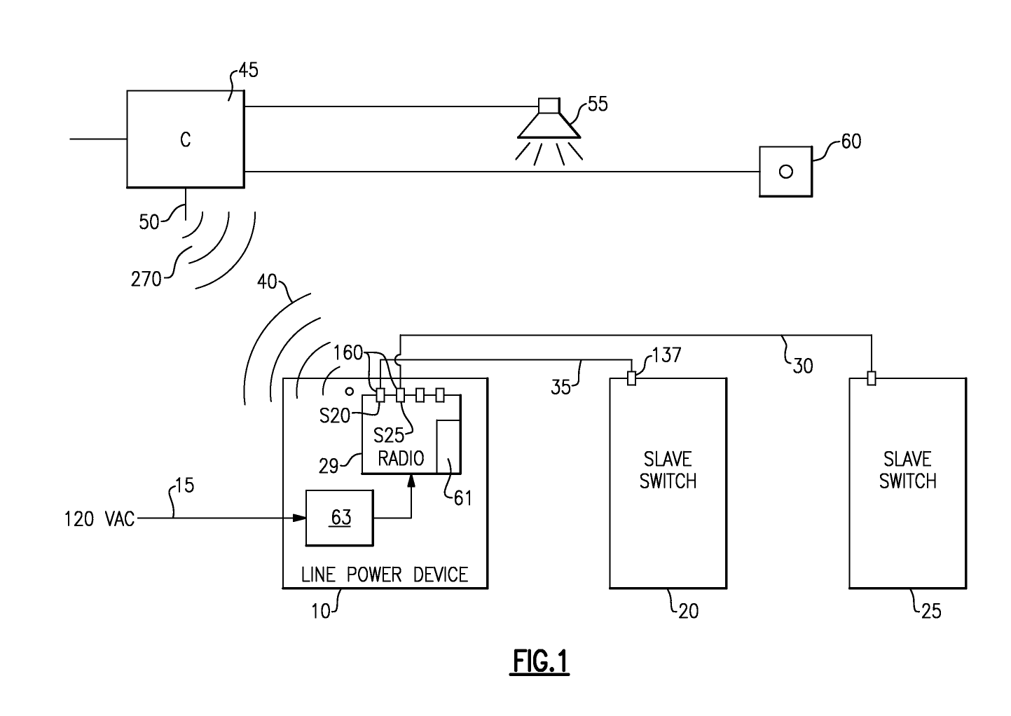

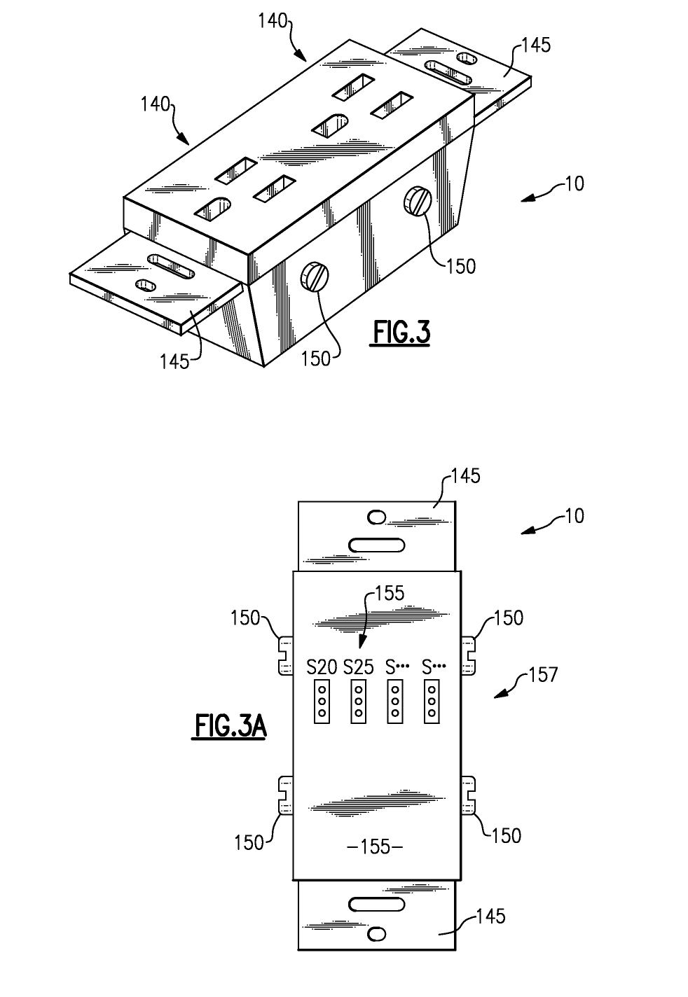

Referring to FIG. 1, a line-powered device 10 receives 120 volt AC power therein via line 15. Slave switches 20 and 25 are each discreetly connected to a radio 29 within the line-powered device 10 via wires 30 and 35. Upon receiving signal 40 from the slave switches 20 or 25 via wire 30 or 35, discreet signal 40 relating to each switch 20, 25 are sent by the radio 29 and are received by a controller 45 via antenna 50 to control powered items such as light 55 or speaker 60. Many other items can be controlled by a slave switch 20 or 25 via the controller 45 such as appliances, HVAC systems, Miscellaneous Electrical Loads (MELs), water heaters, security systems, or the like. Other voltages than 120 v AC are contemplated herein, including low voltage DC power and line voltages commonly used in other countries as an example. The line-powered device 10 may include a transformer or other device 63 therein to allow the radio to use the line 15 power as is known in the art. As shown in FIG. 1, the line-powered device 10 may have a controller 61 for diverting power to any of the slave connection ports as will be shown in FIG. 3A and discussed infra.

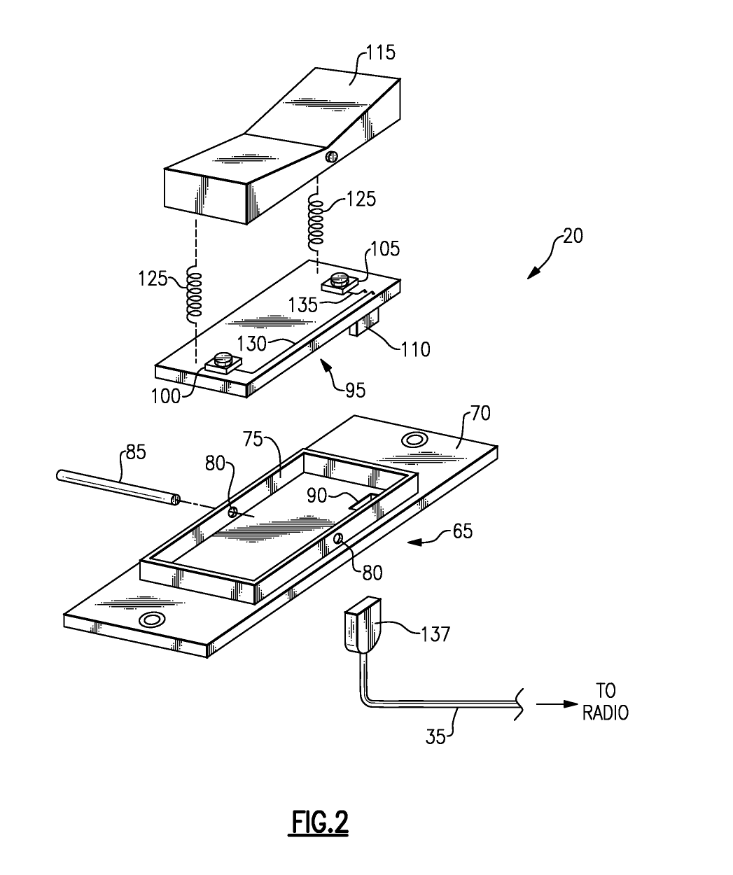

Referring now to FIG. 2, an exploded slave switch 20 is shown. Each switch includes a housing 65, including a flat body 70, a box-like enclosure 75 mounted on the body 70, the enclosure 75 having a pair of holes 80 that align with each other for receiving a pin 85 therein. The body 70 has a rectangular opening 90 therein as will be discussed infra. A rectangular printed circuit board 95 has an ON contact switch 100 and an OFF contact switch 105 on the top thereof and a connector 110 that fits within the rectangular opening 90 in the body 70. The printed circuit board 95 fits within the box-like enclosure 75 under the holes 80. The contact switches are shown as having an ON position and an OFF position but other functions such as status including “higher” or “lower”, or “hotter” or “cooler”, or “in” or “out”, or the like are contemplated herein.

A rocker 115 has a pair of openings 120 for receiving the pin 85 therethrough. Springs 125 are disposed between the rocker and the printed circuit board 95 to enable the rocker 115 to return to an initial position after a user presses the rocker to either the ON position or the OFF position. If the rocker contacts the ON switch 100 a signal is sent via wire 130 or the OFF switch 105 a signal 40 is sent via wire 135 to the connector 110, to the wire 35, to the radio 29 for transmission to the controller 45.

To assemble a slave switch 20, the printed circuit board 95 is placed within the box-like enclosure 75, with its connector 110 disposed within the opening 90. The springs 125 are placed under each end of the rocker 115 and the pin 20 is extended through the openings in the rocker 115 and in the box-like enclosure 75. The wire 30 or 35 is then attached to the connector 110 via a socket 137.

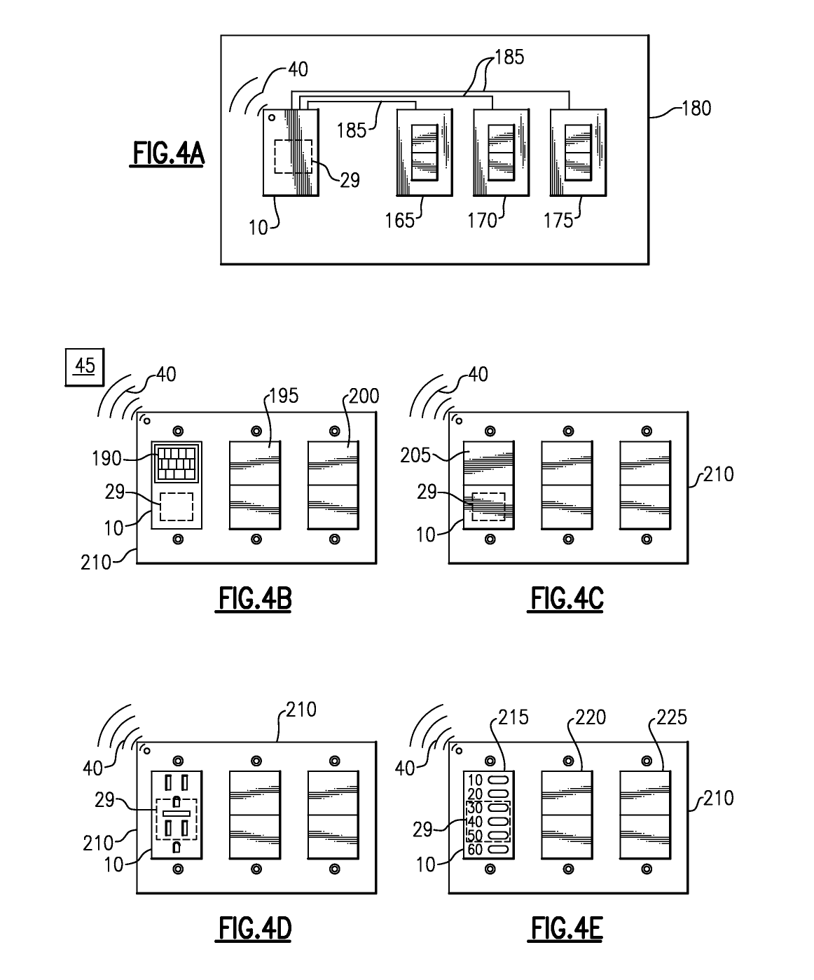

Referring now to FIG. 3, a line-powered device 10 including a radio (not shown) is shown. The device 10 has a pair of sockets 140 in which a standard plug (not shown) may be inserted, a pair of flanges 145 for attaching to a standard electrical box (not shown), and a pair of attachment screws 150 for receiving and passing power therethrough as is known in the art. Referring to FIG. 3A, the back 157 of the line-powered device 10 includes a plurality of ports 155 that receive signal 40 from slave switches 20, 25 . . . (see FIG. 1) that may be remotely placed (see FIGS. 1 and 4A). Each wire 30, 35 has a second socket 160 (see FIG. 1).

Referring now to FIGS. 4A-4E, 4A is a device similar to that line-powered device 10 shown in FIG. 1 with a line-powered device 10 including a radio 29 and a plurality of electrical components such as slave switches 165, 170, 175. The slave switches 165, 170, 175 may be placed anywhere in a home or building 180 though efficiency in using wiring 185 to couple these slave switches 165, 170, 175 to the line-powered device 10 is a factor. As shown in FIG. 4B, the line-powered device 10 that includes a radio 29 radio may incorporate an electrical component such as an occupancy sensor 190 that communicates with radio 29 to send signals 40 to controller 45 as to room occupancy while sending signals 40 a slave switch 195 or a slave switch 200. In FIG. 4C, the radio 29 may also be incorporated in a master switch 205 and still be receiving and sending signals 40 from slave switches while sending signals 40 to the controller (See FIG. 1). Referring now to FIG. 4D, the line-powered device 10, incorporating the radio 29, as shown in FIG. 3 is incorporated into a box 210 in which slave switches are utilized and a pair of outlet sockets are used. Similarly, in 4E, the radio enabled device is incorporated into a timer 215 and the slave switches 220 and 225 send signals 40 to the timer for transmission to the controller. FIGS. 4A-4E show that the radio 29 may be incorporated into any line-powered device 10 and be coupled with other electrical components such as switches, sockets, sensors, etc. in a box 210 or outside of a box (see FIG. 4A).

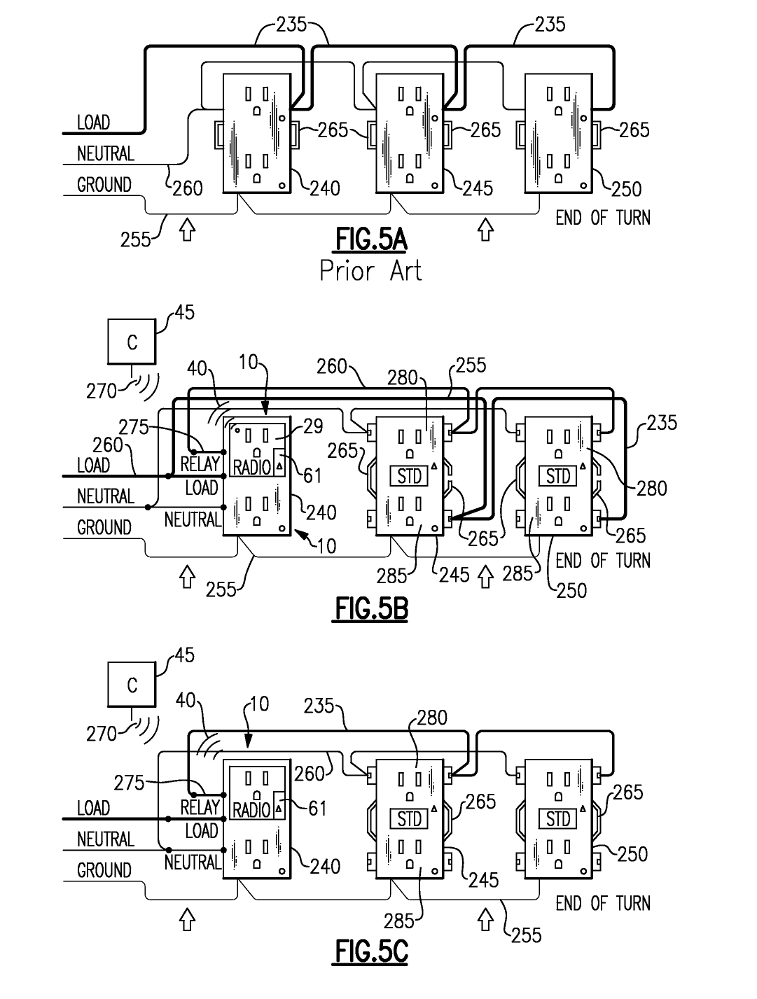

Referring now to FIG. 5A, shows a normal prior art standard duplex wiring where a load 235 passes through and to three socket sets 240, 245, 250 as is known in the art. Each socket set 240, 245, 250 also has a ground 255 and a neutral 260 wired thereto also as known in the art. Each socket set 240, 245, 250 also has half-hot connectors 265 that are not disconnected in this figure.

Referring to FIG. 5B the socket pair 240 is a line-powered device 10 as shown in FIG. 1 in that it includes a controller 61. Upon receiving a signal 270 via radio 29, the controller 61 activates a power switch such as relay 275 that controls power to the upper sockets 280 on the second and third standard socket sets 245, 250 by way of relay wiring 260. This enables the controller 61 to control power to the upper half of second and third socket sets 245, 250 via relay 275 by means of a half hot wiring method as shown in FIG. 5B. Note that the half hot connectors 265 on the load circuit have been broken in the socket sets 245, 250 so that the bottom sockets 285 always receive power via line 235 at the same time isolating the top sockets 280. The signal 270 from the controller 45 may allow an appliance (not shown) plugged into the upper sockets 280 to be switched on and off. Note that bottom socket set 240 is always on.

Similarly, in FIG. 5C, the radio controlled device 10 will now control both sockets in each socket set. Upon receiving a signal 270 by radio 29, the controller 61 activates a relay 275 that controls power to electrical components such as the second and third socket sets 245, 250. This enables the controller 61 to control power to the second and third socket sets 245, 250 via relay 275. Note that the half hot connector 265 is not broken in the socket sets 245, 250 so that relay 275 controls power to the upper sockets 280 and the lower sockets 285 of the socket sets 245, 250. The signal 270 from the controller 45 may allow an appliance (not shown) plugged into the upper sockets 280 and/or the lower sockets 285 to be switched on and off. Note that socket set 240 is always on.

By allowing several devices as shown herein to share a radio, a large cost benefit is realized as compared to systems in which a radio is embedded within each device. In addition, miscommunications and poor RF system performance is minimized by minimizing (e.g., by sharing) the number of radios in a system, again, as compared to a system in which every device contains a radio.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A system for controlling distribution of power comprising:
a line-powered electrical device including a radio,
a plurality of electrical components disposed electrically downstream from said line-powered electrical device and receiving power from said line-powered electrical device, and
a first controller wirelessly receiving or sending signals from said radio included with said line-powered electrical device.

2. The system of claim 1 wherein said electrical components are at an end of an electrical line.

3. The system of claim 1 wherein said electrical components comprise at least one switch that sends a discrete signal to said line-powered electrical device.

4. The system of claim 1 wherein said electrical components comprise at least one socket.

5. The system of claim 1 wherein said line-powered device comprises a sensor.

6. The system of claim 5 wherein said sensor is an occupancy sensor.

7. The system of claim 1 wherein said line-powered device comprises a timer.

8. The system of claim 1 wherein said line-powered device further comprises a relay for controlling power to said plurality of electrical components.

9. The system of claim 8 wherein said relay is controlled by a second controller disposed in said line-powered device.

10. The system of claim 9 wherein said plurality of electrical components includes a socket set that receives more than one plug and having a half-hot connector.

11. The system of claim 10 wherein said second controller receives a signal from said first controller to control power to one plug in said socket set via activation of said relay.

12. The system of claim 10 wherein said second controller receives a signal from said first controller to control power to more than one plug in said socket set via activation of said relay.

13. The system of claim 1 wherein said a line-powered electrical device further includes a transformer.

14. A method for controlling distribution of power comprising:
providing a electrical device including a radio,
providing line power to said electrical device including a radio,
disposing a plurality of electrical components electrically downstream from said line-powered electrical device,
providing power to said electrical components via said electrical device, and
receiving or sending signals via said radio to a remotely placed first controller.

15. The method of claim 14 further comprising:
providing a discrete signal corresponding to one or more electrical component to said electrical device, and
transmitting a signal to said first controller corresponding to said discrete signal to control power to an electrical item.

16. The method of claim 14 further comprising:
providing a switch in a power line between said electrical device and said plurality of electrical components.

17. The method of claim 16 further comprising:
providing a second controller with said line-powered device and
controlling said switch in said power line upon said radio receiving a signal from said first controller.

18. The method of claim 16 further comprising:
controlling a half hot socket set.
